(19) United States
(12) Patent Application Publication
(10) Pub. No.: US 2016/0124403 A1
(43) Pub. Date: May 5, 2016

(54) METHOD AND SERVER OF CUSTOMIZING SCENARIO MODE FOR SMART DEVICES

(71) Applicant: Xiaomi Inc., Beijing (CN)

(72) Inventors: Qiang Fu, Beijing (CN); Yang Wang, Beijing (CN); Qiao Ren, Beijing (CN); Ming Zhao, Beijing (CN)

(21) Appl. No.: 14/749,633

(22) Filed: Jun. 25, 2015

Related U.S. Application Data
(63) Continuation of application No. PCT/CN2015/074621, filed on Mar. 19, 2015.

(30) Foreign Application Priority Data
Oct. 29, 2014 (CN) 201410594190.4

(51) Int. Cl. G05B 15/02; H04L 12/28

(52) U.S. Cl. CPC G05B 15/02; H04L 12/2816

(57) ABSTRACT

The present disclosure provides a method and a server of customizing a scenario mode for smart devices. The method includes: obtaining device information of a plurality of smart devices bound to a user account; pushing, according to the device information of the smart devices, a device startup condition list and a device task list to a controlling device bound to the user account, respectively; receiving, from the controlling device, selection information indicating a selected startup condition and a selected device task; and establishing, according to the selection information, a scenario mode for the smart devices, wherein the smart devices comprise at least one first smart device and at least one second smart device, and the scenario mode represents an operation mode for controlling actions of the at least one second smart device according to a status parameter collected by the at least one first smart device.

### CROSS-REFERENCE TO RELATED APPLICATIONS

This application is a Continuation application of International Application No. PCT/CN2015/074621, filed with the State Intellectual Property Office of P. R. China on Mar. 19, 2015, which is based upon and claims priority to Chinese Patent Application No. 201410594190.4, filed with the State Intellectual Property Office of P. R. China on Oct. 29, 2014, the entire contents of which are incorporated herein by reference.

### TECHNICAL FIELD

The present disclosure generally relates to a field of smart home suite, and more particularly, to a method and a server for customizing a scenario mode for smart devices.

### BACKGROUND

Home appliances have become an essential in people's daily life. Conventional home appliances are generally remotely controlled by users through touch buttons or infrared remote controllers. With the development of the home appliances, conventional operation modes are no longer able to meet requirements of the users for controlling the home electrical appliances.

Conforming to this trend, a concept of a smart home is proposed. The smart home uses a house as a platform, integrates facilities related to home life together by using a comprehensive wiring technology, a network communication technology, a security protection technology, an automatic control technology, an audiovisual technology, and establishes an efficient management system of the facilities related to home life and normal daily routines, thus improving safety, accessibility, comfort and artistry of the home and achieving an eco-friendly living environment. This concept has been widely considered to be an inevitable trend of the home appliances in the future.

### SUMMARY

According to a first aspect of embodiments of the present disclosure, there is provided a method of customizing a scenario mode for smart devices. The method includes: obtaining device information of a plurality of smart devices bound to a user account; pushing, according to the device information of the smart devices, a device startup condition list and a device task list to a controlling device bound to the user account, respectively; receiving, from the controlling device, selection information indicating a selected startup condition and a selected device task; and establishing, according to the selection information, a scenario mode for the smart devices, wherein the smart devices comprise at least one first smart device and at least one second smart device, and the scenario mode represents an operation mode for controlling actions of the at least one second smart device according to a status parameter collected by the at least one first smart device.

According to a second aspect of embodiments of the present disclosure, there is provided a server of customizing a scenario mode for smart devices. The server includes: a processor; and a memory configured to store instructions executable by the processor, wherein the processor is configured to perform: obtaining device information of a plurality of smart devices bound to a user account; pushing, according to the device information of the smart devices, a device startup condition list and a device task list to a controlling device bound to the user account, respectively; receiving, from the controlling device, selection information indicating a selected startup condition and a selected device task; and establishing, according to the selection information, a scenario mode for the smart devices, wherein the smart devices comprise at least one first smart device and at least one second smart device, and the scenario mode represents an operation mode for controlling actions of the at least one second smart device according to a status parameter collected by the at least one first smart device.

According to a third aspect of embodiments of the present disclosure, there is provided a non-transitory computer-readable storage medium having stored therein instructions that, when executed by a processor of a server, causes the server to perform a method of customizing a scenario mode for smart devices. The method includes: obtaining device information of a plurality of smart devices bound to a user account; pushing, according to the device information of the smart devices, a device startup condition list and a device task list to a controlling device bound to the user account, respectively; receiving, from the controlling device, selection information indicating a selected startup condition and a selected device task; and establishing, according to the selection information, a scenario mode for the smart devices, wherein the smart devices comprise at least one first smart device and at least one second smart device, and the scenario mode represents an operation mode for controlling actions of the at least one second smart device according to a status parameter collected by the at least one first smart device.

It is to be understood that both the foregoing general description and the following detailed description are exemplary and explanatory only and are not restrictive of the invention, as claimed.

### BRIEF DESCRIPTION OF THE DRAWINGS

In order to explicitly illustrate embodiments of the present disclosure, a brief introduction for the accompanying drawings corresponding to the embodiments will be listed as follows. Apparently, the drawings described below are only corresponding to some embodiments of the present disclosure, and those skilled in the art may obtain other drawings according to these drawings without creative labor.

FIG. 1 is a flow chart showing a method of customizing a scenario mode for smart devices according to an exemplary embodiment.

FIG. 2 is a flow chart showing a method for generating a list according to an exemplary embodiment.

FIG. 3A is a first schematic diagram illustrating an interface of a controlling device for user to configure a scenario mode according to an exemplary embodiment.

FIG. 3B is a second schematic diagram illustrating an interface of the controlling device for user to configure a scenario mode according to an exemplary embodiment.

FIG. 3C is a third schematic diagram illustrating an interface of the controlling device for user to configure a scenario mode according to an exemplary embodiment.

FIG. 3D is a fourth schematic diagram illustrating an interface of the controlling device for user to configure a scenario mode according to an exemplary embodiment.

FIG. 4 is a flow chart showing a method for controlling a smart device based on a scenario mode according to an exemplary embodiment.

FIG. 5 is a schematic diagram illustrating an apparatus for customizing a scenario mode for smart devices according to an exemplary embodiment.

FIG. 6 is a schematic diagram illustrating a selection list pushing module according to an exemplary embodiment.

FIG. 7 is a schematic diagram illustrating an apparatus for controlling a smart device based on a scenario mode according to an exemplary embodiment.

FIG. 8 is a block diagram of a server for customizing a scenario mode for smart devices according to an exemplary embodiment.

Embodiments of the present disclosure have already been illustrated with reference to above drawings, and will be described more detail in the following description. These drawings and text description are not intended to limit the scope of the present disclosure in any way, but are used to explain the concept of the present disclosure to those skilled in the art with reference to special embodiments.

### DETAILED DESCRIPTION

In order to make objectives, technical solutions and advantages of the present disclosure clearer, in the following the present disclosure will be described in detail with reference to drawings. Apparently, the described embodiments are only some embodiments of the present disclosure and do not represent all the embodiments. Based on the embodiment described herein, all the other embodiments obtained by those skilled in the art without creative labor belong to the protection scope of the present disclosure.

Embodiments are associated with a smart suite network system comprising a controlling device, a plurality of smart devices and a server. Firstly, it should be noted that, in various embodiments of the present disclosure, the controlling device may be an electronic device selecting from a group of phones, tablet computers, e-book readers, MP3 players (Moving Picture Experts Group Audio Layer III), MP4 players (Moving Picture Experts Group Audio Layer IV), portable laptops, and desktop computers and etc.

The controlling device may be one of the plurality of smart devices. Alternatively, the controlling device can also be a separate device besides the plurality of smart devices. For example, the smart devices may comprise a smart sockets, smart cameras, smart TVs and smart air conditioners in a smart home suite system. In one embodiment, the controlling device may be the smart TV among the home appliances. In other embodiments, the controlling device may be not one of the home appliances but a mobile phone. The controlling device and the plurality of smart devices are connected to the server by an external communication network. Moreover, the controlling device and the plurality of smart devices can be registered under a same user account. The server stores the registration information, user account information, device information of the controlling device and the plurality of smart devices and other necessary information to manage the controlling device and the plurality of smart devices.

Accordingly, the present disclosure provides a method of utilizing a user to set some operation mode to monitor or obtain status parameters of the plurality of smart devices in the smart suite network system. Moreover, control operations can be conducted based on the monitoring results according to the operation mode.

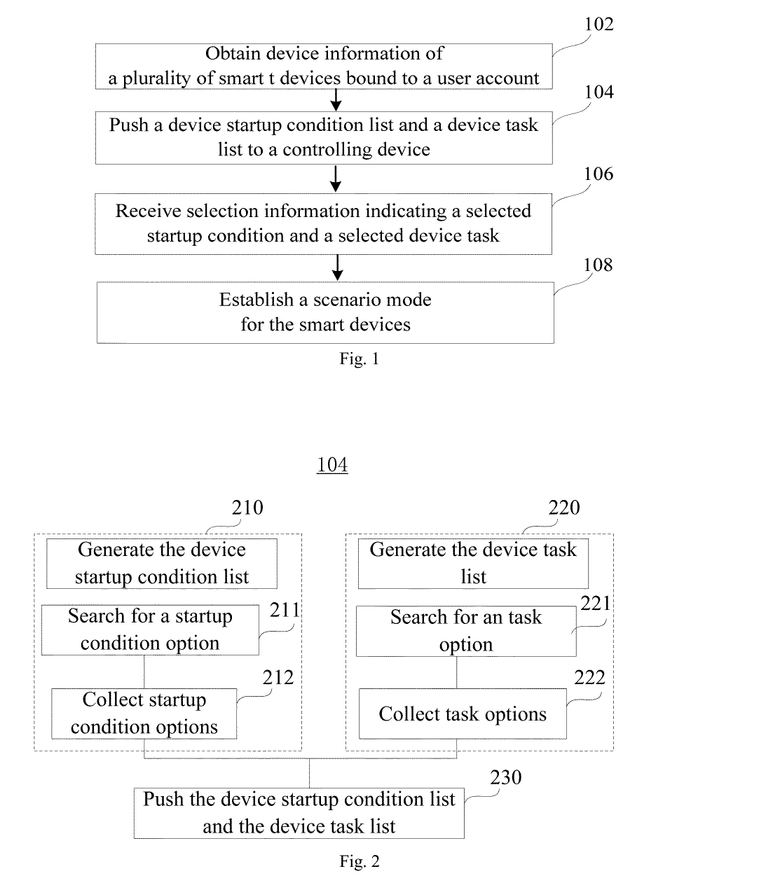

FIG. 1 is a flow chart showing a method of customizing a scenario mode for smart devices according to an exemplary embodiment. In this embodiment, take the method being implemented by the server as an example to illustrate. The method includes the following steps.

In step 102, device information of a plurality of smart device bound to a user account is obtained.

In step 104, a device startup condition list and a device task list are pushed respectively to a controlling device bound to the user account according to the device information of the smart devices.

In step 106, selection information indicating a selected startup condition and a selected device task is received from the controlling device.

In step 108, a scenario mode is established according to the selection information.

Herein, the smart devices comprise at least one first smart device and at least one second smart device, and the scenario mode represents an operation mode for controlling actions of the at least one second smart device according to a status parameter collected by the at least one first smart device.

This embodiment provides the user with a method of customizing a scenario mode for smart devices. In this method, the device information of the plurality of smart device bound to the user account is obtained by the server. And then the device startup condition list and the device task list matching the device information of the plurality of smart device are generated and pushed respectively to the controlling device bound to the user account according to the device information of the smart devices. The user only needs to operate on the controlling device to perform a selection from the device startup condition list and the device task list. After a user-preferred device startup condition and device task is selected and a linkage between the selected startup condition and the selected task is configured, the user may send his selection and configuration result to the server. Then the server may establish a relevant scenario mode for controlling the smart devices.

The smart device cited in this embodiment may be a smart home appliance or gadget. However, it should be noted that, the smart device cited in this embodiment does not be limited to a smart home appliance or gadget, it can include any device, component, furniture, tool, machine, car, or other things which can be electronically controlled and connected to a local or internet network.

In this embodiments, the smart devices comprise at least one first smart device and at least one second smart device, and the scenario mode is configured to indicate an operation mode for controlling actions of the at least one second smart device according to a status parameter collected by the at least one first smart device. By establishing the scenario mode bound to the user account in the server, an automatic control of the at least one second smart device may be realized.

Moreover, when the server establishes the scenario mode by using a scenario mode configuration. In some embodiments, the scenario mode configuration at least comprises parameters selected from: user account information, the device information of the smart devices, a startup condition parameter for defining conditions of triggering the scenario mode, and a task parameter for defining actions to be performed in the scenario mode.

User account information represents information of the use account. In the present disclosure, the controlling device and the smart devices are registered under a same user account. The user account is identified by the server by using the user account information such as a user name (login name, screen name or nickname), a phone number of the user, or an email address of the user and etc.

As for the device information of the smart devices, in the present disclosure, it includes: device information of the at least one first smart device bound to the user account and device information of the at least one second smart device bound to the user account. The device information includes device ID information and device type information. The device ID information may be a MAC (Media Access Control) address, an IP address, a device serial number and the like. The device type information indicates different types of the devices, such as smart sockets, smart cameras, smart TVs, smart air conditioners, and etc. As for different types of devices, different status parameters are collected and different control instructions are sent by the server.

The startup condition is the status parameter collected by the at least one first smart device and set as a condition for triggering the scenario mode. The status parameter collected by the devices may be different since the device types are different. For example, the smart socket may collect a current ON/OFF state of the smart socket, the smart camera may collect whether there is a moving object within the monitoring range, the smart air conditioner may collect a current indoor temperature and a current ON/OFF state of the smart air conditioner, etc. All these status parameters may be used as the status parameter collected by the first smart device.

The task is a corresponding control instruction configured to be sent to the at least one second smart device if the scenario mode is triggered. The corresponding control instructions may be different since the device types are different. For example, the smart socket may control the ON/OFF status of the smart socket, the smart air conditioner may control the ON/OFF status of the smart air conditioner and the set temperature etc.

In this embodiment, the device information includes the device ID information and the device type information. Since different types of smart devices may provide different status parameter as the startup conditions, they are corresponding to different control instructions. According to the device information obtained, the server may obtain the startup condition options provided and available to the smart device bound to the user account and used as the startup conditions, and may obtain the task options provided and available to the smart device bound to the user account and used as the tasks, and thus generates the device startup condition list and the device task list. FIG. 2 is a flow chart showing a method for generating the above list according to an exemplary embodiment. Referring to FIG. 2, the above step of pushing the device startup condition list and the device task list according to the device information of the at least one smart device includes the following steps.

In step 210, the device startup condition list matching the at least one smart device is generated according to the device type information of the at least one smart device, wherein the device startup condition list comprises a set of startup condition options available to the at least one smart device.

In step 220, the device task list is generated according to the device type information of the at least one smart device, wherein the device task list is a set of task options available to the at least one smart device.

In step 230, the device startup condition list and the device task list are sent to the controlling device respectively.

Further, in some embodiments, in step 210, the device startup condition list is generated by using the following sub-steps.

In sub-step 211, a search is performed according to the device type information of the smart devices to determine the device startup condition options available to each of the smart devices.

In sub-step 212, the startup condition options are collected to generate the device startup condition list.

Further, in some embodiments, in step 220, the device task list is generated by using the following sub-steps.

In sub-step 221, a search is performed according to the device type information of the smart devices to determine the device task options available to each of the smart devices.

In sub-step 222, the device task options are collected to generate the device task list.

Alternatively, after that the task options available to the smart devices are further screened according to the selection information, the device task list is generated.

In other words, firstly, the server pushes the generated device startup condition list to the user account, and then screens the task options available to the at least one smart device and used as the tasks according to the selection information when the user account returns the selection information on the device startup condition list, and finally generates the device task list based on the screened task options. With this method, the task options in the device task list may be further reduced, and the user's selection burden may also be reduced.

Moreover, in another embodiment, the method of customizing a scenario mode for smart devices may further includes a step of obtaining user account information of the user account. Accordingly, the scenario mode is established based on the obtained user account information, the device information of the at least one first smart device and the at least one second smart device, the selected device startup condition, and the selected device task.

In this embodiment, specific configuration of the user account information, the device information of the bound smart device, the startup condition and the task needed to establish the scenario mode are illustrated specifically.

In summary, in this embodiment, the device information bound to the user account obtained by the server may include the device type information. Since different types of smart devices may provide different status parameter as the startup conditions, they are corresponding to different control instructions. Based on this, a database may be established in advance in the server, wherein the database includes startup condition options available to various types of smart devices and used as the startup conditions and task options available to the various types of smart devices and used as the tasks. According to the device type information of the smart device bound to the user account obtained by the server, the server searches for the startup condition options and the task options respectively corresponding to the various smart devices based on the database. And then the server collects the startup condition options and the task options available to the various smart devices bound to the user account, thus obtaining the device startup condition list and the device task list. The user only needs to select in the device startup condition list and the device task list. After a user-preferred device startup condition and device task is selected and a linkage between the selected startup condition and the selected task is configured, the user may send his selection and configuration result to the server. Then the server may establish a relevant scenario mode for controlling the smart devices.

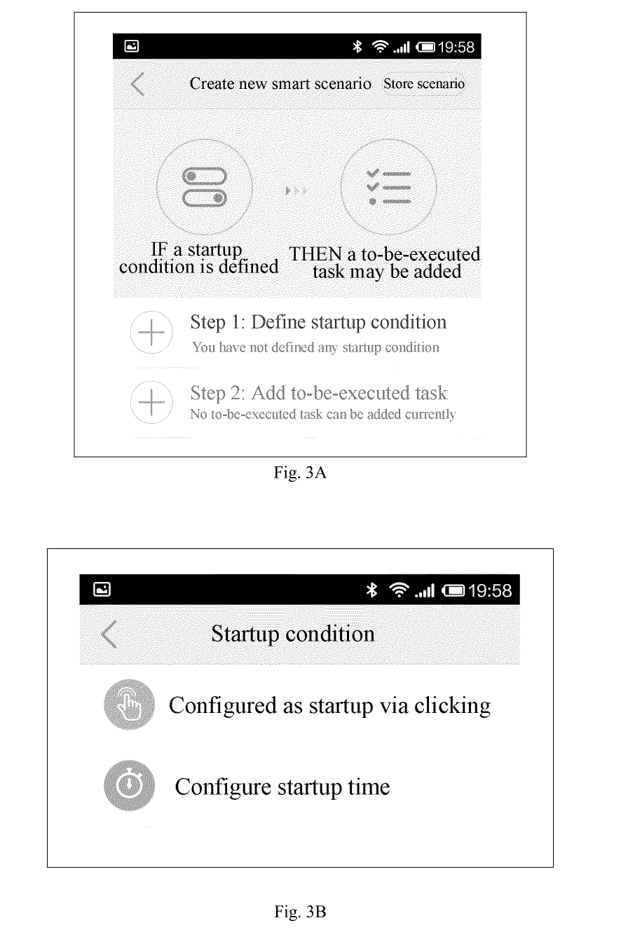

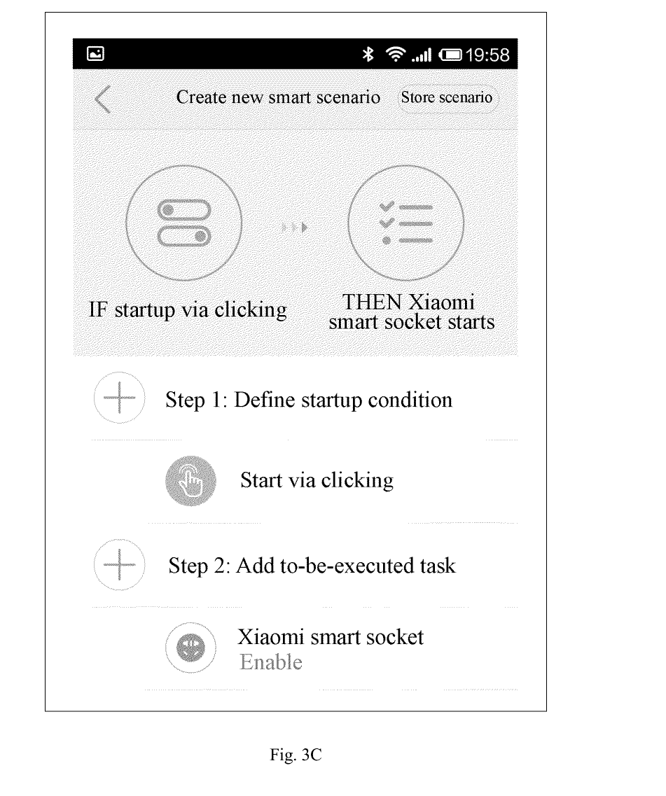

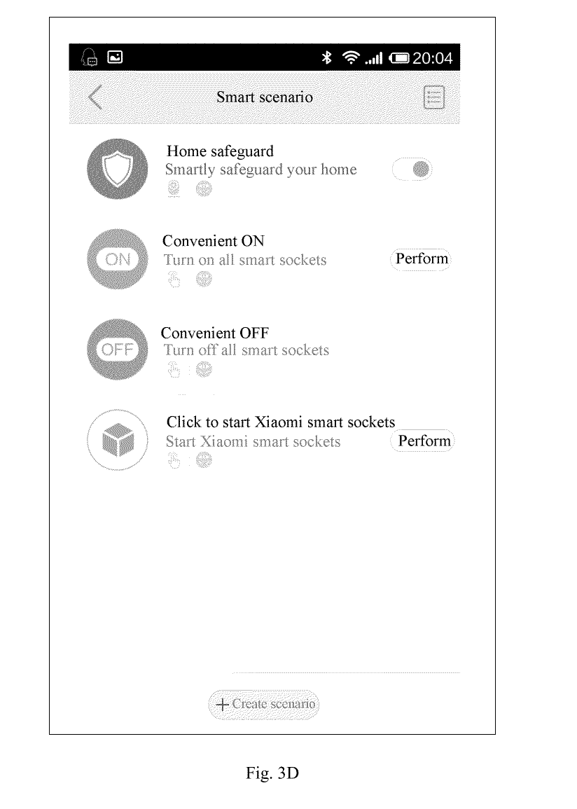

FIG. 3A is the first schematic diagram illustrating an interface of the controlling device for user to configure a scenario mode according to an exemplary embodiment, FIG. 3B is the second schematic diagram illustrating an interface of the controlling device for user to configure a scenario mode according to an exemplary embodiment, FIG. 3C is the third schematic diagram illustrating an interface of the controlling device for user to configure a scenario mode according to an exemplary embodiment and FIG. 3D is the fourth schematic diagram illustrating an interface of the controlling device for user to configure a scenario mode according to an exemplary embodiment.

Referring to FIGS. 3A-3D, an example of customizing a scenario mode of a smart device by the user is provided in this embodiment. Referring to FIG. 3A, in this embodiment, a free-choice menu of the startup conditions and the tasks (also called “to-be-executed tasks”) on the scenario mode is provided for the user. The user may obtain the device startup condition list and the device task list from the server. Herein, in the server, the two lists are generated based on the smart devices bound to the user account. Referring to FIG. 3B, the device startup condition list may include two startup condition options, i.e., “Configured as startup via clicking” and “Configure startup time”. Referring to FIG. 3C, the user selects “Configured as startup via clicking” as the startup condition of the scenario mode and “XiaoMi smart socket—ON” as the task of the scenario mode by selecting in the list. Referring to FIG. 3D, if the user's selection is confirmed and saved, the scenario mode is established. Herein the scenario mode is based on the phone and MI smart socket bound to the user account as the first smart device and the second smart device, wherein the startup condition is “clicking” and the task is “Turning on the XiaoMi smart socket”. The linkage between the two smart devices (the phone and XiaoMI smart socket) bound to the user may be established by setting the scenario mode.

In this embodiment, there may be a plurality of first smart devices in the scenario mode. The status parameter corresponding to each first smart device may be used as one factor in the startup conditions which are used to determine whether to trigger the scenario mode. With respect to this situation, in the method for customizing a scenario mode of a smart device, the following two configuration schemes for setting a logic conjunction between the plurality of first smart devices may be provided for the user.

Configuration Scheme 1:

The scenario mode further includes a startup condition logic conjunction. The startup condition logic conjunction is configured to represent a logic conjunction between status parameter collected by each first smart device and used as the condition for triggering the scenario mode. The logic conjunction herein may be a logic “AND” or a logic “OR” or a logical expression composed of the logic “AND” and the logic “OR”.

Receiving selection information of the device startup condition list and the device task list selected by the user account further includes receiving setting information on the startup condition logic conjunction for the user account.

Establishing a scenario mode bound to the user account according to the selection information of the device startup condition list and the device task list further includes setting the logic startup condition relationship of the scenario mode according to the setting information on the startup condition logic conjunction.

With this method, the status parameter collected by each smart device may be used as one factor of determining whether to trigger the scenario mode. The basis for determining whether to trigger the scenario mode may be established through establishing the logical expressions between various factors. The user may set the startup condition logic conjunction according to the setting information on the startup condition logic conjunction, and thus the desired startup condition logic conjunction may be combined.

Configuration Scheme 2:

The scenario mode further includes a condition-task correspondence table. At least one group of corresponding relationship between the startup condition and the task is stored in the condition-task correspondence table.

Receiving selection information of the device startup condition list and the device task list selected by the user account further includes receiving setting information on the condition-task correspondence table for the user account.

Establishing a scenario mode bound to the user account according to the selection information of the device startup condition list and the device task list further includes setting a condition-task correspondence table of the scenario mode according to the setting information on the condition-task correspondence table.

With this method, the condition-task correspondence table may be established in the scenario mode to determine the corresponding relationship between the startup conditions and the tasks. The user's requirements of setting management between different startup conditions and different tasks may be satisfied by means of the condition-task correspondence table.

Since the status parameter collected by some first smart devices has specific status parameter values, for example, the indoor temperature collected by the air conditioner, the current water temperature collected by the water heater, etc. According to the user's requirements, these parameters are needed to be determined with specific parameter values, and in this embodiment, the method for customizing a scenario mode of a smart device includes following details.

Receiving selection information of the device startup condition list and the device task list selected by the user account further includes receiving status parameter setting information of the status parameter collected by the at least one first smart device and used as the condition for triggering the scenario mode.

Establishing a scenario mode bound to the user account according to the selection information of the device startup condition list and the device task list further includes setting on the status parameter collected by the at least one first smart device and used as the startup condition in the scenario mode according to the status parameter setting information.

With this method, the status parameter setting information on the status parameter may be provided for the user while the selection information is returned. By setting the status parameter setting information on the status parameter, the setting of the specific parameter values of the status parameter may be realized.

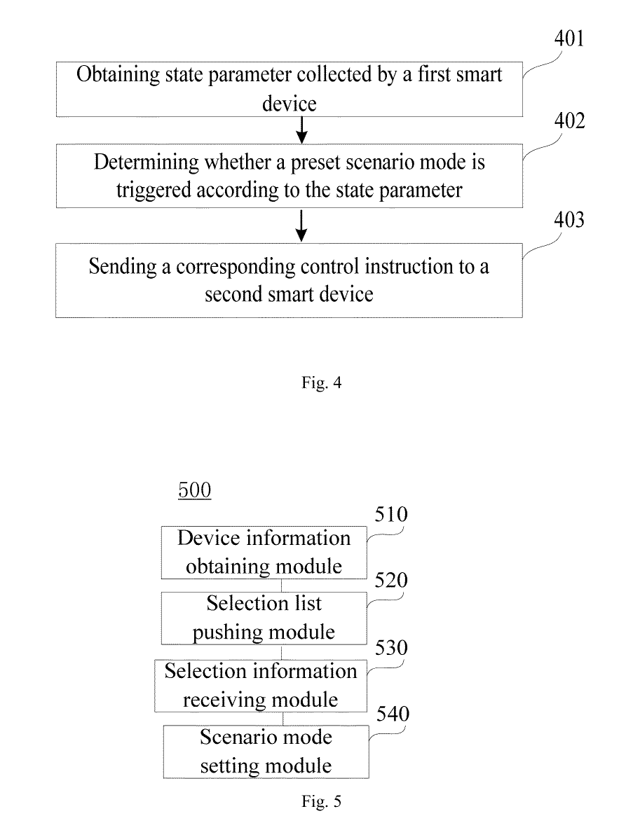

FIG. 4 is a flow chart showing a method for controlling a smart device based on a scenario mode according to an exemplary embodiment. In this embodiment, take the method being used in a server as an example. Referring to FIG. 4, the method for controlling a smart device based on a scenario mode includes the following steps.

In step 401, status parameter collected by at least one first smart device bound to a user account is obtained.

In step 402, it is determined whether a preset scenario mode is triggered according to the status parameter, wherein the scenario mode is configured to store an associated relationship for triggering to control at least one second smart device according to the status parameter collected by the at least one first smart device.

In step 403, if the preset scenario mode is triggered, a corresponding control instruction is sent to the at least one second smart device bound to the user account according to the scenario mode, so as to control the at least one second smart device to operate correspondingly.

In summary, with the method for controlling a smart device based on a scenario mode according to this embodiment, the different smart devices may be associated with each other via the scenario modes pre-stored in a cloud server as a media, so that an automatic linkage control may be performed on the different smart devices based on the associated relationships which are set in the scenario modes. With this method for controlling a smart device based on a scenario mode, originally independent smart devices may be linked with each other, and with the combination of the smart devices, application scenarios of the smart devices may be extended.

The smart device cited in this embodiment may be a smart home device. It should be noted that, the method for controlling a smart device has the strong extendibility and compatibility, and as long as the smart device has the internet connection compatibility, the method for controlling the smart device in this embodiment may be applied.

The scenario mode at least includes user account information, device information of a bound smart device, a startup condition and a task.

The device information of the bound smart device includes: device information of the at least one first smart device bound to the user account and device information of the at least one second smart device bound to the user account. The device information includes device ID information and device type information. The device ID information may be a MAC (Media Access Control) address, an IP address, a device serial number and the like. The device type information is type information of the device, such as smart sockets, smart cameras, smart TVs, smart air conditioners, etc. Therefore, different types of devices may collect different status parameter and may be corresponding to different control instructions.

The startup condition is the status parameter collected by the at least one first smart device and set as a condition for triggering the scenario mode. The status parameter collected by the devices may be different since the device types are different. For example, the smart socket may collect a current ON/OFF state of the smart socket, the smart camera may collect whether there is a moving object within the monitoring range, the smart air conditioner may collect a current indoor temperature and a current ON/OFF state of the smart air conditioner, etc. These status parameters may be used as the status parameter collected by the first smart device.

The task is a corresponding control instruction configured to be sent to the at least one second smart device if the scenario mode is triggered. The corresponding control instructions may be different since the device types are different. For example, the smart socket may control the ON/OFF status of the smart socket, the smart air conditioner may control the ON/OFF status of the smart air conditioner and the set temperature etc.

In this embodiment, there may be a plurality of first smart devices in the scenario mode. The status parameter corresponding to each first smart device may be used as one factor in the staring conditions which are used to determine whether to trigger the scenario mode. Herein, in the case of multiple first smart devices, it may be determined whether the scenario mode is trigged in two ways.

Way 1:

The scenario mode further includes a startup condition logic conjunction. The startup condition logic conjunction is configured to represent a logic conjunction between status parameter collected by each first smart device and to be used as the condition for triggering the scenario mode. The logic conjunction may be a logic “AND” or a logic “OR” or a logical expression composed of the logic “AND” and the logic “OR”.

Determining whether a preset scenario mode is triggered according to the status parameter includes: determining whether a logic conjunction between the status parameter collected by each first smart device meets the startup condition logic conjunction according to the status parameter, wherein if the logic conjunction between the status parameter collected by each first smart device meets the startup condition logic conjunction, the preset scenario mode is triggered.

With this method, the status parameter collected by each smart device may be used as the one factor of determining whether to trigger the scenario mode. The basis of determining whether to trigger the scenario mode may be established through establishing the logical expressions between various factors.

Way 2:

The scenario mode further includes a condition-task correspondence table, and at least one group of corresponding relationship between the startup condition and the task is stored in the condition-task correspondence table.

Determining whether a preset scenario mode is triggered according to the status parameter includes: determining whether the status parameter collected by at least one first smart device meets at least one group of startup condition in the condition-task correspondence table according to the status parameter.

If the status parameter collected by at least one first smart device meets at least one group of startup condition in the condition-task correspondence table, the task corresponding to the at least one group of startup condition is triggered according to the condition-task correspondence table.

With this method, the condition-task correspondence table may be established in the scenario mode to determine the corresponding relationship between the startup condition and the task. With the correspondence table, different startup conditions and different tasks may be managed.

Device embodiments of the present disclosure which may be configured to perform method embodiments of the present disclosure will be described in the following. With respect to undisclosed details in the following device embodiments, please refer to the method embodiments.

FIG. 5 is a schematic diagram illustrating an apparatus for customizing a scenario mode of a smart device according to an exemplary embodiment. This apparatus may be implemented by the hardware, software or the combination thereof to be part of an electronic device or an electronic device. The apparatus 500 for customizing a scenario mode of a smart device includes a device information obtaining module 510, a selection list pushing module 520, a selection information receiving module 530 and a scenario mode setting module 540.

The device information obtaining module 510 is configured to obtain device information of at least one smart device bound to a user account.

The selection list pushing module 520 is configured to push a device startup condition list and a device task list matching the device information of the at least one smart device respectively to the user account according to the device information of the at least one smart device.

The selection information receiving module 530 is configured to receive selection information of the device startup condition list and the device task list selected by the user account.

The scenario mode setting module 540 is configured to establish a scenario mode bound to the user account according to the selection information of the device startup condition list and the device task list, wherein the scenario mode is configured to store an associated relationship for triggering to control at least one second smart device according to status parameter collected by at least first smart device.

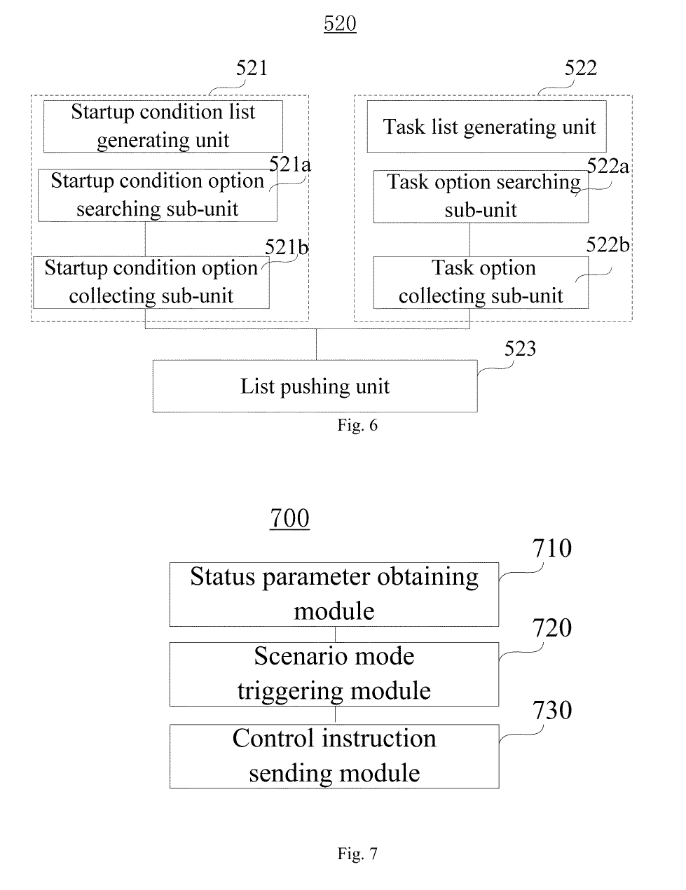

FIG. 6 is a schematic diagram illustrating a selection list pushing module according to an exemplary embodiment. Referring to FIG. 6, the selection list pushing module 520 includes a startup condition list generating unit 521, a task list generating unit 522 and a list pushing unit 523.

The startup condition list generating unit 521 is configured to generate the device startup condition list matching the at least one smart device according to the device type information of the at least one smart device, wherein the device startup condition list is a set of startup condition options available to the at least one smart device and used as the startup conditions.

The task list generating unit 522 is configured to generate the device task list matching the at least one smart device according to the device type information of the at least one smart device, wherein the device task list is a set of task options available to the at least one smart device and used as the tasks.

The list pushing unit 523 is configured to push the device startup condition list and the device task list to the user account respectively.

Further, the startup condition list generating unit 521 includes a startup conditions option searching sub-unit 521a and a startup condition option collecting sub-unit 521b.

The startup condition option searching sub-unit 521a is configured to search for a startup condition option available to each smart device bound to the user account and used as the startup condition according to the device type information of the smart device.

The startup condition option collecting sub-unit 521b is configured to collect the startup condition options available to each smart device to generate the device startup condition list.

The task list generating unit 522 includes a task option searching sub-unit 522a and an task option collecting sub-unit 522b.

The task option searching sub-unit 522a is configured to search for an task option available to each smart device bound to the user account and used as the task according to the device type information of the smart device.

The task option collecting sub-unit 522b is configured to collect task options available to each smart device bound to the user account to generate the device task list.

Alternatively, the task list generating unit 522 further includes an task option screening sub-unit, and the task option screening sub-unit is configured to screen the task options available to the at least one smart device and used as the tasks according to the selection information of the device startup condition list selected by the user account, so as to generate the device task list.

In other words, firstly, the server pushes the generated device startup condition list to the user account, and then screens the task options available to the at least one smart device and used as the tasks according to the selection information when the user account returns the selection information on the device startup condition list, and finally generates the device task list based on the screened task options. With this method, the task options in the device task list may be further reduced, and the user's selection burden may also be reduced.

In this embodiment, the apparatus for customizing a scenario mode of a smart device includes following details.

The device information obtaining module 510 is further configured to obtain user account information of the user account.

The scenario mode setting module 540 is further configured to establish the scenario mode with a selected startup condition option as the startup condition of the scenario mode and a selected task option as the task of the scenario mode, wherein the user account information of the scenario mode is the user account information obtained, and for the device information of the bound smart device, the device information of the smart device corresponding to the selected startup condition option is used as the device information of the first smart device, the device information of the smart device corresponding to the selected task option is used as the device information of the second smart device.

In this embodiment, specific configuration of the user account information, the device information of the bound smart device, the startup condition and the task needed to establish the scenario mode are illustrated specifically.

In this embodiment, there may be a plurality of first smart devices in the scenario mode. The status parameter corresponding to each first smart device may be used as one factor in the startup conditions which are used to determine whether to trigger the scenario mode. With respect to this situation, in the apparatus for customizing a scenario mode of a smart device, two configuration schemes for setting a logic conjunction between the plurality of first smart devices may be provided for the user.

Configuration Scheme 1:

The scenario mode further includes a startup condition logic conjunction. The startup condition logic conjunction is configured to represent a logic conjunction between status parameter collected by each first smart device and used as a condition for triggering the scenario mode. The logic conjunction herein may be a logic “AND” or a logic “OR” or a logical expression composed of the logic “AND” and the logic “OR”.

The selection information receiving module 530 is further configured to receive setting information on the startup condition logic conjunction for the user account.

The scenario mode setting module 540 is further configured to set a logic startup condition relationship of the scenario mode according to the setting information on the startup condition logic conjunction.

With this apparatus, the status parameter collected by each smart device may be used as one factor of determining whether to trigger the scenario mode. The basis for determining whether to trigger the scenario mode may be established through establishing the logical expressions between the various factors. The user may set the startup condition logic conjunction according to the setting information on the startup condition logic conjunction, and thus the desired startup condition logic conjunction may be combined.

Configuration Scheme 2:

The scenario mode further includes a condition-task correspondence table, and at least one group of corresponding relationship between the startup condition and the task is stored in the condition-task correspondence table.

The selection information receiving module 530 is further configured to receive setting information on the condition-task correspondence table for the user account.

The scenario mode setting module 540 is further configured to set a condition-task correspondence table of the scenario mode according to the setting information on the condition-task correspondence table.

With this apparatus, the condition-task correspondence table may be established in the scenario mode to determine the corresponding relationship between the startup conditions and the tasks. The user's requirements of setting management between different startup conditions and different tasks may be satisfied by means of the condition-task correspondence table.

Since the status parameter collected by some first smart devices has specific status parameter values, for example, the indoor temperature collected by the air conditioner, the current water temperature collected by the water heater, etc. According to the user's requirements, these parameters are needed to be determined with specific parameter values, and in this embodiment, the apparatus for customizing a scenario mode of a smart device includes following details.

The selection information receiving module 530 is further configured to receive status parameter setting information of the status parameter collected by the at least one first smart device and used as the condition for triggering the scenario mode.

The scenario mode setting module 540 is further configured to set on the status parameter collected by the at least one first smart device and used as the startup condition in the scenario mode according to the status parameter setting information.

With this apparatus, the status parameter setting information on the status parameter may be provided for the user while the selection information is returned. By setting the status parameter setting information on the status parameter, the setting of the specific parameter values of the status parameter may be realized.

FIG. 7 is a schematic diagram illustrating an apparatus for controlling a smart device based on a scenario mode according to an exemplary embodiment. This apparatus may be implemented by the hardware, software or the combination thereof to be part of an electronic device or an electronic device. The apparatus 700 for controlling a smart device based on a scenario mode includes a status parameter obtaining module 710, a scenario mode triggering module 720 and a control instruction sending module 730.

The status parameter obtaining module 710 is configured to obtain status parameter collected by at least one first smart device bound to a user account.

The scenario mode triggering module 720 is configured to determine whether a preset scenario mode is triggered according to the status parameter, wherein the scenario mode is configured to store an associated relationship for triggering to control at least one second smart device according to the status parameter collected by the at least one first smart device.

The control instruction sending module 730 is configured to send a corresponding control instruction to the at least one second smart device bound to the user account according to the scenario mode if the preset scenario mode is triggered, so as to control the at least one second smart device to operate correspondingly.

Alternatively, the scenario mode at least includes user account information, device information of a bound smart device, a startup condition and an task;

The device information of the bound smart device includes: device information of the at least one first smart device bound to the user account and device information of the at least one second smart device bound to the user account.

The startup condition is the status parameter collected by the at least one first smart device and set as a condition for triggering the scenario mode.

The task is a corresponding control instruction configured to be sent to the at least one second smart device if the scenario mode is triggered.

Alternatively, the scenario mode further includes a startup condition logic conjunction.

The startup condition logic conjunction is configured to represent a logic conjunction between status parameter collected by each first smart device and used as the condition for triggering the scenario mode.

The scenario mode triggering module 720 includes a logic conjunction determining unit.

The logic conjunction determining unit is configured to determine whether a logic conjunction between the status parameter collected by each first smart device meets the startup condition logic conjunction according to the status parameter, wherein if the logic conjunction between the status parameter collected by each first smart device meets the startup condition logic conjunction, the preset scenario mode is triggered.

Alternatively, the scenario mode further includes a condition-task correspondence table.

At least one group of corresponding relationship between the startup condition and the task is stored in the condition-task correspondence table.

The scenario mode triggering module 720 includes a condition-task correspondence table querying unit.

The condition-task correspondence table querying unit is configured to determine whether the status parameter collected by each first smart device meets at least one group of startup condition in the condition-task correspondence table according to the status parameter, wherein if the status parameter collected by each first smart device meets at least one group of startup condition in the condition-task correspondence table, the task corresponding to the at least one group of startup condition is triggered according to the condition-task correspondence table.

In summary, with the apparatus for controlling a smart device based on a scenario mode according to this embodiment, the different smart devices may be associated with each other via the scenario modes pre-stored in a cloud server as a media, so that an automatic linkage control may be performed on the different smart devices based on the associated relationships which are set in the scenario modes. With this apparatus for controlling a smart device based on a scenario mode, the originally independent smart devices may be linked, and with the combination of the smart devices, application scenarios of the smart devices may be extended.

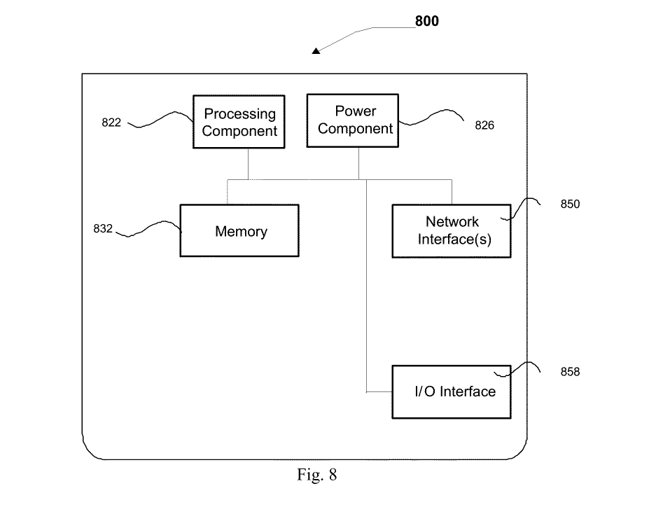

FIG. 8 is a block diagram of a server 800 of customizing a scenario mode for smart devices according to an exemplary embodiment. Referring to FIG. 8, the server 800 may include a processing component 822 further including one or more processors, and memory resources represented by a memory 832, configured to store instruction executed by the server 800, for example, applications. The applications stored in the memory 832 may includes one or more modules wherein each module is corresponding to a group of instructions. In addition, the processing component 822 is configured to execute the instructions to perform all or part of the steps in the above described methods.

The server 800 further includes a power component 826 configured for a power management of the server 800, a wireless network interface 850 configured to connect the server 800 to the network, and an input/output (I/O) interface 858. The server 800 may be based on an operating system stored in the memory 832, for example, Windows Server™, Mac OS X™, Unix™, Linux™, FreeBSD™ and the like.

A non-transitory computer-readable storage medium having stored therein instructions that, when executed by a processor of the server 800, causes the server 800 to perform a method for customizing a scence mode shown in FIG. 1.

A non-transitory computer-readable storage medium having stored therein instructions that, when executed by a processor of the device 800, causes the device 800 to perform a method for controlling a smart device shown in FIG. 4.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method of customizing a scenario mode for smart devices, comprising:
obtaining device information of a plurality of smart devices bound to a user account;
pushing, according to the device information of the smart devices, a device startup condition list and a device task list to a controlling device bound to the user account, respectively;
receiving, from the controlling device, selection information indicating a selected startup condition and a selected device task; and
establishing, according to the selection information, a scenario mode for the smart devices,
wherein the smart devices comprise at least one first smart device and at least one second smart device, and the scenario mode represents an operation mode for controlling actions of the at least one second smart device according to a status parameter collected by the at least one first smart device.

2. The method according to claim 1, wherein the scenario mode is established based on a scenario mode configuration comprising parameters selected from: user account information, the device information of the smart devices, a startup condition parameter for defining conditions of triggering the scenario mode, and a task parameter for defining actions to be performed in the scenario mode.

3. The method according to claim 2, wherein the device information of the smart devices comprises device information of the at least one first smart device and device information of the at least one second smart device;
wherein the startup condition parameter comprises the status parameter collected by the at least one first smart device for triggering the scenario mode; and
wherein the task parameter comprises a predefined control instruction to be sent to the at least one second smart device when the scenario mode is triggered.

4. The method according to claim 3, wherein the device information comprises device ID information and device type information.

5. The method according to claim 4, wherein pushing the device startup condition list and the device task list comprises:
generating the device startup condition list according to the device type information of the smart devices, wherein the device startup condition list comprises a set of startup condition options available to the smart devices;
generating the device task list according to the device type information of the smart devices, wherein device task list comprises a set of task options available to the smart devices; and
sending the device startup condition list and the device task list to the controlling device, respectively.

6. The method according to claim 5, wherein generating the device startup condition list according to the device type information of the smart devices comprises:
performing a search, according to the device type information of the smart devices, to determine the device startup condition options available to each of the smart devices; and
collecting the startup condition options to generate the device startup condition list.

7. The method according to claim 5, wherein generating the device task list according to the device type information of the smart devices comprises:
performing a search, according to the device type information of the smart devices, to determine the device task options available to each of the smart devices; and
collecting the device task options to generate the device task list.

8. The method according to claim 5, further comprising:
generating the device task list after screening the task options available to the smart devices according to the selection information.

9. The method according to claim 2, wherein the method further comprises: obtaining the user account information for the user account; and
wherein the scenario mode is established based on the obtained user account information, the device information of the at least one first smart device and the at least one second smart device, the selected device startup condition, and the selected device task.

10. A server of customizing a scenario mode for smart devices, comprising:
a processor; and
a memory configured to store instructions executable by the processor,
wherein the processor is configured to perform:
obtaining device information of a plurality of smart devices bound to a user account;
pushing, according to the device information of the smart devices, a device startup condition list and a device task list to a controlling device bound to the user account, respectively;
receiving, from the controlling device, selection information indicating a selected startup condition and a selected device task; and
establishing, according to the selection information, a scenario mode for the smart devices,
wherein the smart devices comprise at least one first smart device and at least one second smart device, and the scenario mode represents an operation mode for controlling actions of the at least one second smart device according to a status parameter collected by the at least one first smart device.

11. The server according to claim 10, wherein the scenario mode is established based on a scenario mode configuration comprising parameters selected from: user account information, the device information of the smart devices, a startup condition parameter for defining conditions of triggering the scenario mode, and a task parameter for defining actions to be performed in the scenario mode.

12. The server according to claim 11, wherein the device information of the smart devices comprises device information of the at least one first smart device and device information of the at least one second smart device;
wherein the startup condition parameter comprises the status parameter collected by the at least one first smart device for triggering the scenario mode; and
wherein the task parameter comprises a predefined control instruction to be sent to the at least one second smart device when the scenario mode is triggered.

13. The server according to claim 12, wherein the device information comprises device ID information and device type information.

14. The server according to claim 13, wherein pushing the device startup condition list and the device task list comprises:
generating the device startup condition list according to the device type information of the smart devices, wherein the device startup condition list comprises a set of startup condition options available to the smart devices;
generating the device task list according to the device type information of the smart devices, wherein device task list comprises a set of task options available to the smart devices; and
sending the device startup condition list and the device task list to the controlling device, respectively.

15. The server according to claim 14, wherein generating the device startup condition list according to the device type information of the smart devices comprises:
performing a search, according to the device type information of the smart devices, to determine the device startup condition options available to each of the smart devices; and
collecting the startup condition options to generate the device startup condition list.

16. The server according to claim 14, wherein generating the device task list according to the device type information of the smart devices comprises:
performing a search, according to the device type information of the smart devices, to determine the device task options available to each of the smart devices; and
collecting the device task options to generate the device task list.

17. The server according to claim 14, wherein the processor is configured to perform:
generating the device task list after screening the task options available to the smart devices according to the selection information.

18. The server according to claim 11, wherein the processor is configured to perform: obtaining the user account information for the user account; and
wherein the scenario mode is established based on the obtained user account information, the device information of the at least one first smart device and the at least one second smart device, the selected device startup condition, and the selected device task.

19. A non-transitory computer-readable storage medium having stored therein instructions that, when executed by a processor of a server, causes the server to perform a method of customizing a scenario mode for smart devices, the method comprising:
obtaining device information of a plurality of smart devices bound to a user account;
pushing, according to the device information of the smart devices, a device startup condition list and a device task list to a controlling device bound to the user account, respectively;
receiving, from the controlling device, selection information indicating a selected startup condition and a selected device task; and
establishing, according to the selection information, a scenario mode for the smart devices,
wherein the smart devices comprise at least one first smart device and at least one second smart device, and the scenario mode represents an operation mode for controlling actions of the at least one second smart device according to a status parameter collected by the at least one first smart device.

20. The storage medium according to claim 19, wherein the scenario mode is established based on a scenario mode configuration comprising parameters selected from: user account information, the device information of the smart devices, a startup condition parameter for defining conditions of triggering the scenario mode, and a task parameter for defining actions to be performed in the scenario mode.
